(19) United States
(12) Patent Application Publication
(10) Pub. No.: US 2015/0052551 A1
(43) Pub. Date: Feb. 19, 2015

(54) EMERGENCY NOTIFICATION CONTROL DEVICE AND EMERGENCY NOTIFICATION SYSTEM

(71) Applicant: Funai Electro Co., Ltd., Osaka (JP)

(72) Inventor: Shinichi TOGE, Daito-shi (JP)

(21) Appl. No.: 14/456,020

(22) Filed: Aug. 11, 2014

(30) Foreign Application Priority Data
Aug. 19, 2013 (JP) 2013-169459

(51) Int. Cl. H04N 21/81; H04N 21/475

(52) U.S. Cl. CPC H04N 21/814; H04N 21/4755
USPC 725/33

(57) ABSTRACT

An emergency notification control device includes an input unit which inputs settings reflecting user preferences, a storage unit which stores the settings that are input using the input unit, and an emergency notification control unit which switches whether or not to perform an emergency notification based on the settings stored in the storage unit when an emergency broadcast is broadcast.

### BACKGROUND OF THE INVENTION

1. Field of the Invention

The present invention relates to an emergency notification control device.

2. Description of the Related Art

Emergency notification control devices have been known in the past which control notifications of emergency situations when an emergency warning broadcast is broadcast because of the occurrence of an earthquake, tsunami, or the like.

Japanese Patent Application Laid-Open Publication No. 2009-225088, for example, discloses a television device that serves as an emergency notification control device that operates in the following manner. When this television device detects that there is an emergency warning system (EWS) signal, it starts a control circuit and determines the region to be warned. Then, it performs control by determining whether the region where the television device is installed is included in the region to be warned, and if it is included, an emergency warning is output, and if not, no emergency warning is output.

With the conventional television device described above, however, no emergency warning is output when the disaster occurs outside the installed region because the installed region is not included in the region to be warned. Therefore, the device cannot handle situations in which the user of the television device wants to know of disasters that occur outside the installed region, such as where the user's acquaintances live.

### SUMMARY OF THE INVENTION

Preferred embodiments of the present invention provide an emergency notification control device which makes it possible to control emergency notification according to user preferences.

An emergency notification control device according to a preferred embodiment of the present invention includes an input unit configured to input settings reflecting user preferences, a storage unit configured to store the settings that are input using the input unit, and an emergency notification control unit configured and programmed to switch whether or not to perform an emergency notification based on the settings stored in the storage unit when an emergency broadcast is broadcast.

With such a configuration, emergency notification is be controlled according to user preferences when emergency broadcasts are broadcast.

Furthermore, the emergency notification control unit preferably is configured and programmed to switch whether or not to perform an emergency notification by comparing region information contained in the broadcast when the emergency broadcast is broadcast with region settings that reflect user preferences.

By having such a configuration, the user is able to control whether or not to send an emergency notification when the region where the emergency situation occurred is a region set in the user's preferences.

Moreover, the emergency notification control unit preferably is configured and programmed to switch whether or not to perform an emergency notification by comparing emergency situation type information contained in the broadcast when the emergency broadcast is broadcast with type settings that reflect user preferences.

With such a configuration, the user is able to control whether or not to send an emergency notification when the type of emergency situation that occurred is a type that has been set in the user's preferences.

In addition, the emergency notification control unit preferably is configured and programmed to switch whether or not to perform an emergency notification by comparing the number of times the emergency broadcast is broadcast consecutively with a number-of-times setting that reflects user preferences.

With such a configuration, it is possible to exert control so as not to send any emergency notification when the emergency broadcast has been broadcast a number of times that exceeds the setting in user preferences, which therefore reduces a nuisance to the user.

Furthermore, the emergency notification control unit preferably is configured and programmed to transmit an emergency notification command to an external device that does not have broadcast reception functions to cause the external device to perform an emergency notification.

With such a configuration, emergency notification is performed when emergency broadcasts are broadcast, so the user is able to confirm that an emergency situation has occurred, even on external devices that do not have broadcast reception functions.

Moreover, the emergency notification control unit preferably is configured and programmed to transmit video data to an external device that does not have broadcast reception functions to cause the external device to perform an emergency notification by playing the video data.

With such a configuration, emergency notification is performed when emergency broadcasts are broadcast, and the user is able to confirm that an emergency situation has occurred, even on external devices that do not have broadcast reception functions.

In addition, the external device may be a digital media player (DMP) connected to the emergency notification control device over a home network, for example.

In this configuration, furthermore, the device is an emergency notification control device that is configured to perform content playback, and when content is being played, the emergency notification control unit is configured to halt the playback operation and perform an emergency notification.

With such a configuration, playback is halted when an emergency broadcast is broadcast, so the user is more likely to notice an emergency notification.

Moreover, when the broadcast of the emergency broadcast terminates after the playback operation is halted, the playback operation preferably is resumed.

By having such a configuration, playback preferably resumes automatically when the emergency broadcast terminates, thus increasing convenience for the user.

In addition, the emergency notification system according to another preferred embodiment of the present invention includes an emergency notification control device including an input unit configured to input settings reflecting user preferences, a storage unit configured to store the settings that are input using the input unit, a detection unit configured to detect that an emergency broadcast has been broadcast, and an emergency notification control unit configured and programmed to switch whether or not to perform an emergency notification based on the settings stored in the storage unit when the detection unit detects an emergency broadcast, and a notification device configured to perform an emergency notification by controlling the emergency notification control unit.

Having such a configuration makes it possible to control emergency notification according to user preferences when an emergency broadcast is broadcast, so emergency notification is preferably performed by a notification device that is separate from the emergency notification control device.

Furthermore, the notification device preferably is configured to perform an emergency notification by on-screen display (OSD) or by playing specified content upon receipt of an emergency notification command transmitted by the emergency notification control unit.

Moreover, an operation may be possible in which the notification device is configured so as not to perform any emergency notification in spite of the fact that the emergency notification command is received.

With such a configuration, it is possible to handle needs of users who desire not to have emergency notification performed even when there is an emergency broadcast.

In addition, the notification device may preferably be configured to perform an emergency notification by playing video data transmitted by the emergency notification control unit.

Furthermore, the notification device may preferably be configured to perform content playback, and emergency notification may be performed after halting playback if content is being played.

With such a configuration, playback preferably is halted when an emergency broadcast is broadcast, so the user is more likely to notice an emergency notification.

Moreover, the emergency notification control device preferably includes a command transmission unit configured to send a command to the notification device when the detection unit detects that the emergency broadcast has terminated, and the notification device preferably resumes the halted playback upon receipt of the command.

With such a configuration, the halted playback resumes automatically when the emergency broadcast terminates, thus increasing convenience for the user.

Various preferred embodiments of the present invention make it possible to control emergency notification according to user preferences.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a block configuration diagram of the television device according to a first preferred embodiment of the present invention.

FIG. 2 is a flowchart pertaining to the emergency notification control processing according to the first preferred embodiment of the present invention.

FIG. 3 is a flowchart pertaining to the emergency notification control processing according to a second preferred embodiment of the present invention.

FIG. 4 is a flowchart pertaining to the emergency notification control processing according to a third preferred embodiment of the present invention.

FIG. 5 is a block configuration diagram of the television device according to a fourth preferred embodiment of the present invention.

FIG. 6 is a flowchart pertaining to the emergency notification control processing according to the fourth preferred embodiment of the present invention.

### DETAILED DESCRIPTION OF THE PREFERRED EMBODIMENTS

### First Preferred Embodiment

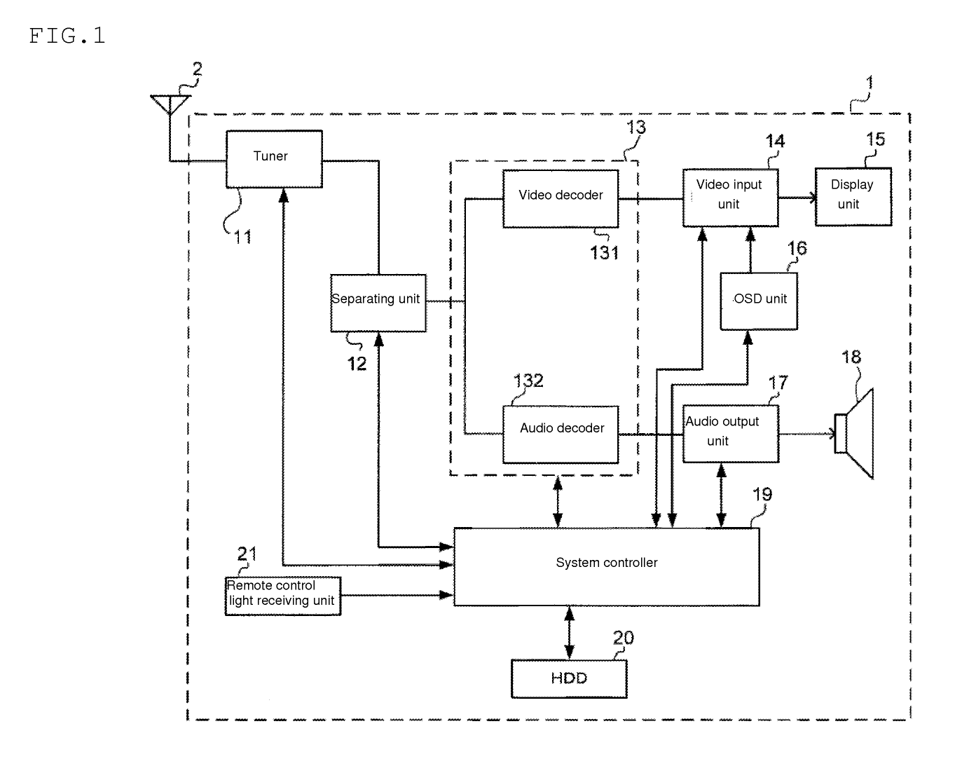

A first preferred embodiment of the present invention will be described below with reference to drawings. Here, a description will be given by citing a television device as one example of the emergency notification control device. FIG. 1 shows a block diagram showing a schematic configuration of the television device according to the first preferred embodiment of the present invention.

The television device 1 shown in FIG. 1 preferably includes a tuner 11, a separating unit 12, a decoding unit 13, a video output unit 14, a display unit 15, an on-screen display (OSD) unit 16, an audio output unit 17, a built-in speaker 18, a system controller 19, a hard disk drive (HDD) 20, and a remote control light-receiving unit 21. An antenna 2 is connected to the tuner 11.

The tuner 11 is used to handle terrestrial digital broadcasts, for example; it selects the desired channel broadcast signal from high-frequency broadcast signals that are input from the antenna 2, performs processing such as digital demodulation and error correction on the broadcast signal of the selected channel, generates a transport stream, and outputs it to the separating unit 12. Furthermore, the tuner 11 also performs extraction of transmission and multiplexing configuration control (TMCC) signals from the broadcast signal of the selected channel.

The separating unit (demultiplexer) 12 separates the transport stream that is input from the tuner 11 into a video stream, an audio stream, and the like. The output of the separating unit 12 is input to the decoding unit 13 that preferably includes a video decoder 131 and an audio decoder 132.

The video decoder 131 decodes the video stream that is input from the separating unit 12 and outputs the generated video data to the video output unit 14.

The OSD unit 16 generates display data for on-screen display such as menu displays and outputs it to the video output unit 14.

The video output unit 14 superimposes the display data that is input from the OSD unit 16 onto the video data that is input from the video decoder 131, converts the superimposed video data into a video signal suited to the display unit 15, and outputs it to a display device. Note that there are also cases in which only either the video data that is input from the video decoder 131 or the display data that is input from the OSD unit 16 is converted into a video signal without superimposition, and the video signal is output to the display unit 15.

The display unit 15 preferably is a liquid crystal display, for example, and displays video based on the video signal that is input from the video output unit 14. By doing this, various types of video such as the video of broadcast program and menu screens are displayed on the display unit 15.

The audio decoder 132 decodes the audio stream that is input from the separating unit 12 and outputs the generated audio data to the audio output unit 17. The audio output unit 17 converts audio data that is input from the audio decoder 132 into an audio signal suited to the built-in speaker 18 and outputs it to the built-in speaker 18. The built-in speaker 18 generates audio based on the audio signal that is input from the audio output unit 17. As a result, the audio of the broadcast program is produced from the built-in speaker 18.

The system controller 19 is a control device that comprehensively controls the television device 1. Moreover, the system controller 19 is configured and programmed to run encoding on the video data and audio data sent from the decoding unit 13 and records the encoded data on the HDD 20. The broadcast program is thus able to be recorded on the hard disk built into the HDD 20.

In addition, the video and audio data read from the hard disk built into the HDD 20 is sent to the system controller 19, and the video and audio data is decoded by the system controller 19. The decoded video data is sent to the video output unit 14, the decoded audio data is sent to the audio output unit 17, the video is displayed on the display unit 15, and the audio is produced from the built-in speaker 18. Playback from the HDD 20 is thus accomplished.

The remote control light-receiving unit 21 receives the operating signal such as an infrared signal according to an operation from a remote control device (not shown), converts the received operation signal into a remote control code, and sends the remote control code to the system controller 19. The system controller 19 is configured and programmed to perform a control operation in accordance with the remote control code that is sent. Consequently, the user can operate the television device 1 via the remote control device.

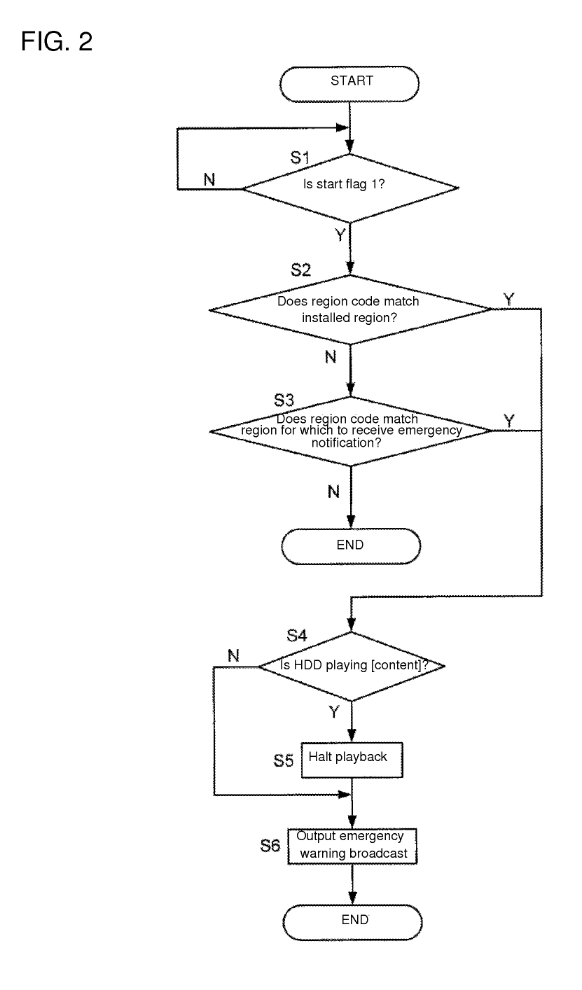

Next, emergency notification control processing in the television device 1 configured in this manner will be described with the use of the flowchart shown in FIG. 2.

Here, the operation of an emergency warning broadcast in a digital broadcast will be described. When an earthquake occurs or a tsunami warning is announced, a broadcast station starts broadcasting content that can be recognized as an emergency warning broadcast.

At this time, an emergency information descriptor is placed within the program map table (PMT) that constitutes the transport stream by the broadcast station. A “start end flag” (1 bit), a type-1/type-2 type (1 bit), and a region code (12 bits) are set within the emergency information descriptor. Furthermore, at the same time, the broadcast station sets the start flag of the TMCC signal to 1. Note that when the emergency warning broadcast terminates, the start flag is set to 0.

At the television device 1, the system controller 19 monitors if the start flag has been set to 1 in the TMCC signal obtained from the tuner 11 as shown in step S1 of FIG. 2. Then, when it is detected that the start flag has become 1 (Y in step S1), the procedure advances to step S2.

In step S2, the system controller 19 determines whether or not the region indicated by the region code in the emergency information descriptor contained in the PMT obtained from the separating unit 12 matches the installed region of the television device 1. The installed region of the television device 1 is set in advance by the user by operating a remote control device or the like (not shown). If the region does not match the installed region of the television device 1 (N in step S2), the procedure advances to step S3.

In step S3, the system controller 19 determines whether or not the region indicated by the region code matches the preset region for which to receive emergency notification. The region for which to receive emergency notification is preset by the user by operating a remote control device or the like, and is a region other than the installed region of the television device 1 (for example, if the installed region is Osaka Prefecture, the region for which to receive emergency notification may be Aichi Prefecture). Note that a plurality of regions for which to receive emergency notification may also be set. When the setting involves operating a remote control device, it is input from the remote control light-receiving unit 21, and the system controller 19 stores the setting information in a storage unit that is not shown. The same applies to settings of user preferences in other preferred embodiments of the present invention described below.

If the region matches the installed region in step S2 (Y in step S2) or the region for which to receive emergency notification in step S3 (Y in step S3), the procedure advances to step S4.

In step S4, the system controller 19 determines whether or not playback is underway from the HDD 20. If playback is underway (Y in step S4), the system controller 19 halts the playback in step S5, and the procedure advances to step S6.

As a result of the system controller 19 controlling the decoder unit 13, video data from the video decoder 131 is output to the video output unit 14, and audio data from the audio decoder 132 is output to the audio output unit 17 in step S6. Accordingly, the video of the emergency warning broadcast is displayed on the display unit 15, and audio of the emergency warning broadcast is produced from the built-in speaker 18. That is, emergency notification is performed.

Note that if playback is not underway from the HDD 20 in step S4 (N in step S4), the procedure advances to step S6, and the emergency warning broadcast is output.

Moreover, if the region indicated by the region code does not match the region for which to receive emergency notification in step S3 (N in step S3), processing terminates at that point (END). Even if playback from the HDD 20 is underway, playback continues, and no emergency warning broadcast is output.

Consequently, in the case of a situation such as an earthquake has occurred in the installed region of the television device 1, the region code indicates the installed region (Y in step S2), so the emergency warning broadcast is output from the display unit 15 and the built-in speaker 18, thus enabling the user to be aware that an emergency situation has occurred.

In addition, in the present preferred embodiment, even in the case of a situation such as an earthquake has occurred in a region for which to receive emergency notification that is not the installed region, the region code indicates a region for which to receive emergency notification (Y in step S3), so the emergency warning broadcast is output from the display unit 15 and the built-in speaker 18, thus enabling the user to be aware that an emergency situation has occurred. This is beneficial in the case of a situation such as the user has acquaintances living in the region for which to receive emergency notification. The region for which to receive emergency notification is set in the user preferences, so emergency notification is controlled in accordance with user preferences.

### Second Preferred Embodiment

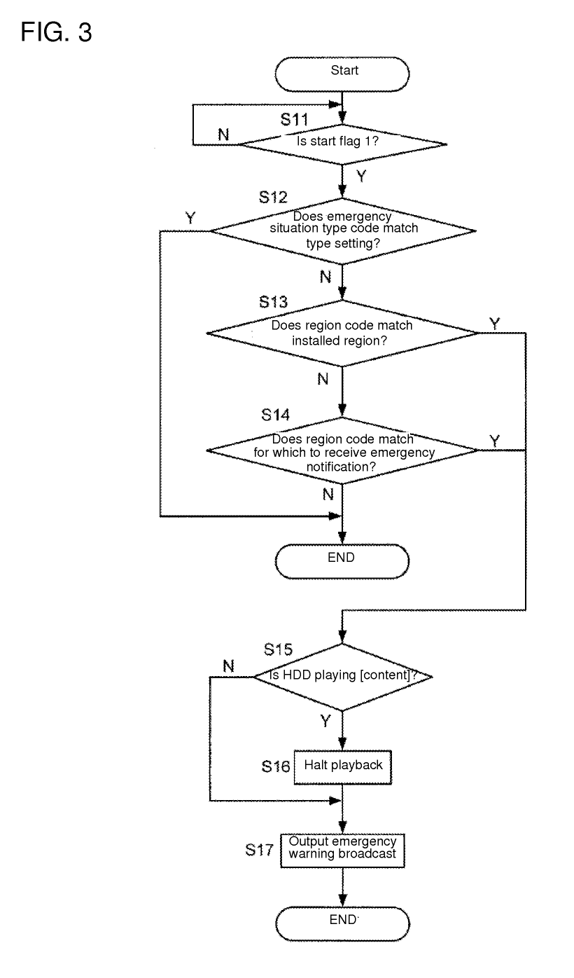

Next, the emergency notification control processing according to a second preferred embodiment of the present invention in the television device 1 having the configuration shown in FIG. 1 will be described with the use of the flowchart shown in FIG. 3.

The processing shown in FIG. 3 differs from the processing shown in FIG. 2 described above in that the processing of step S12 is inserted between steps S11 and S13. When the start flag is monitored and it is detected that the start flag has become 1 (Y in step S11), the procedure advances to step S12, and the system controller 19 checks the emergency situation type code contained in the TMCC signal obtained from the tuner 11.

Here, the emergency situation type code preferably uses the reserve bit of the TMCC signal, for example, and expresses the type of disaster such as earthquake, tsunami, tornado, heatwave, and thunderstorm. Furthermore, the use of this is not limited to disasters but may be applied to events such as the outcome of an election.

In step S12, the system controller 19 determines whether or not the emergency situation type code matches the emergency situation type preset by the user operating a remote control device or the like, and if it matches (Y in step S12), processing terminates at that point (END). If it does not match (N in step S12), the procedure advances to step S13, determination of the region code. Note that it is possible to configure the system such that a plurality of emergency situation types can be set.

Thus, in the present preferred embodiment, if an emergency situation type is preset for which the user does not want an emergency warning broadcast sent, then when the preset emergency situation type occurs, playback continues even if playback from the HDD 20 is underway, for example, and no emergency warning broadcast is reported. Accordingly, nuisance for the user is reduced. Meanwhile, because emergency situation types that are not set will be reported by emergency warning broadcast, the user is able to confirm the occurrence of emergency situations. The emergency situation type is set in the user preferences, so emergency notification is controlled in accordance with user preferences.

### Third Preferred Embodiment

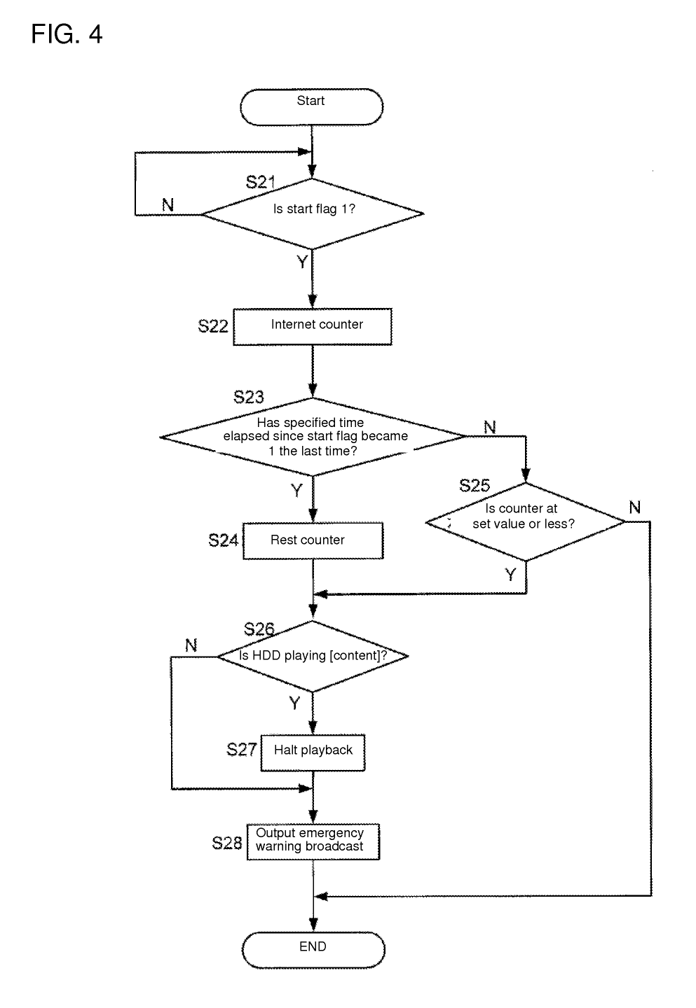

Next, the emergency notification control processing according to a third preferred embodiment of the present invention in the television device 1 having the configuration shown in FIG. 1 will be described using the flowchart shown in FIG. 4.

When the start flag is monitored in step S21 and it is detected that the start flag has become 1 (Y in step S21), the procedure advances to step S22, and the system controller 19 increments the counter.

Next, in step S23, the system controller 19 determines whether or not a specified length of time has passed since the start flag became 1 the last time; if it has (Y in step S23), the procedure advances to step S24. In step S24, the system controller 19 resets the counter. After step S24, the procedure advances to the processing of steps S26 through S28. Steps S26 through S28 are processing similar to steps S4 through S6 of FIG. 2 described above.

Moreover, in step S23, if the specified amount of time has not passed since the start flag became 1 the last time (N in step S23), then the procedure advances to step S25, and the system controller 19 determines whether or not the counter is at or below the set value preset by the user operating a remote control device or the like. If the counter is at or below the set value (Y in step S25), the procedure advances to step S26; if it exceeds the set value (N in step S25), processing ends at that point (END).

For instance, if another disaster occurs, different from the one that occurred the last time, and the specified period of time elapses after the start flag became 1 the last time (Y in step S23), then the counter is reset to 0, for example, in step S24. Then, the emergency warning broadcast is output in step S28.

Thereafter, if the start flag briefly becomes 0 and then promptly becomes 1 again, then the specified period of time has not elapsed since the start flag became 1 the last time (N in step S23), so the procedure advances to step S25. Then, if the set value has been set to 1, for example, the counter is at 1 because of step S22, so the counter is at or below the set value (Y in step S25), and the emergency warning broadcast is output again in step S28.

If thereafter the start flag briefly becomes 0 and then promptly becomes 1 again, the specified period of time has not elapsed since the start flag became 1 the last time (N in step S23), so the procedure advances to step S25. Here, the counter is 2 because of step S22, so the counter exceeds the set value (N in step S25), and the processing terminates at that point. Thus, playback continues even if playback from the HDD 20, for example, is underway, and no emergency warning broadcast is sent.

Thereafter, every time the start flag promptly becomes 1, the counter is incremented in step S22, so the counter exceeds the set value in step S25, and no emergency warning broadcast is sent.

When the emergency warning broadcast is being broadcast consecutively, the emergency warning broadcast is output for only the number of times that the user sets, and the emergency warning broadcast is not output thereafter (in the example in which the set value is 1, the emergency warning broadcast is output only two times). Therefore, nuisance for the user is reduced. The number of times to be set described above is set in the user preferences, so emergency notification is controlled in accordance with user preferences.

### Fourth Preferred Embodiment

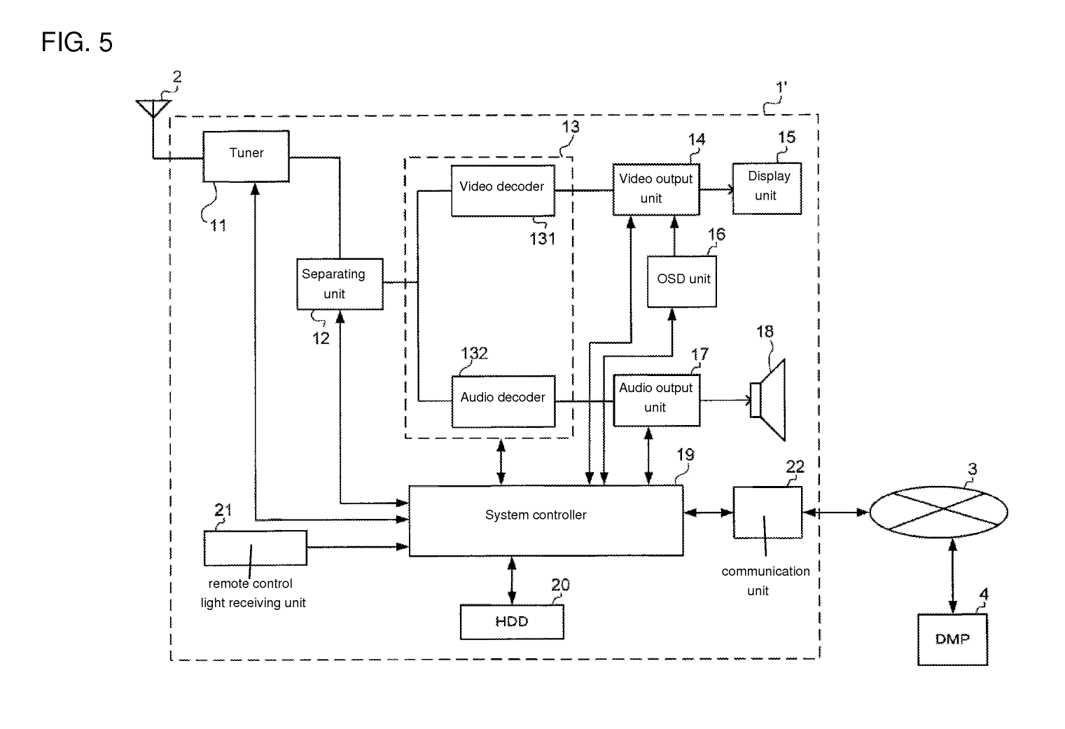

Next, a fourth preferred embodiment of the present invention will be described. FIG. 5 shows a block diagram showing a schematic configuration of the television device according to the present preferred embodiment. The television device 1′ shown in FIG. 1 is equipped with a communication unit 22 in addition to the configuration of the television device 1 shown in FIG. 1 described above.

The communication unit 22 is configured to communicate with a digital media player (DMP) 4 over a home network 3. The connection over the home network 3 is compliant with the Digital Living Network Alliance (DLNA), for example.

The television device 1′ is able to disseminate content stored on the HDD 20 to the DMP 4 using the communication unit 22 and functions as a digital media server (DMS). The DMP 4 is able to play content disseminated from the television device 1′.

Note that the DMP 4 may be equipped with a display unit and a built-in speaker configured to play content, or these devices may be connected externally and not included in the DMP itself. In addition, the DMP 4 may be equipped with an optical disk drive or HDD, for example, so as to be able to play content recorded on a Blu-ray disc or hard disk in addition to disseminated content.

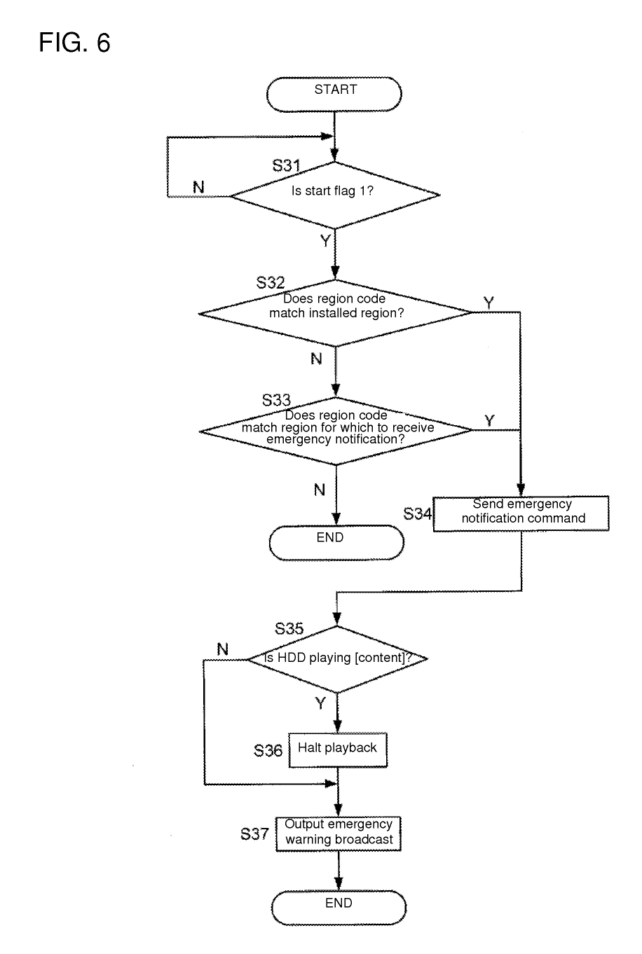

Next, the emergency notification control processing performed by the television device 1′ will be described with the use of the flowchart shown in FIG. 6. The processing shown in FIG. 6 differs from the processing shown in FIG. 2 in that step S34 is provided.

In the processing of FIG. 6, if the region indicated by the region code matches the installed region in step S32 (Y in step S32), or if the region indicated by the region code matches the region for which to receive emergency notification in step S33 (Y in step S33), then the procedure advances to step S34. In step S34, the system controller 19 sends an emergency notification command to the DMP 4 using the communication unit 22.

When the emergency notification command is received at the DMP 4, it displays an on-screen display (OSD) that indicates that an emergency situation has occurred. For example, it displays the following on screen: “WARNING! An emergency earthquake bulletin has been issued!” Note that when the DMP 4 is playing content, the playback is halted before the OSD is displayed. Note that emergency notification is not limited to an OSD, and content specified for emergency notification may also be played.

This allows the user to confirm the occurrence of an emergency situation by an emergency notification command being sent from the television device 1′ when an emergency warning broadcast is broadcast even when the DMP 4 does not have broadcast reception functionality.

Furthermore, as a modified example of the present preferred embodiment, instead of transmitting the emergency notification command in step S34 of FIG. 6, it is also possible to start transmitting the video and audio data of an emergency warning broadcast to the DMP 4 and to play the video and audio data at the DMP 4. Alternatively, specified content for emergency notification stored on the HDD 20 may also be disseminated to the DMP 4.

Note that in the processing shown in FIG. 3, processing to transmit an emergency notification command may be inserted between steps S14 and S15, for example. Moreover, in the processing shown in FIG. 4, processing to transmit emergency notification commands, for example, may be inserted between steps S24, S25, and S26.

In addition, even when an emergency notification command is transmitted, it is also possible to allow an user operation of setting in the DMP 4 so as to ignore this command and not to display OSD or the like.

### Other Preferred Embodiments

Preferred embodiments of the present invention were described above, but a variety of modifications can be made to the preferred embodiments as long as they are within the scope of the gist of the present invention.

For instance, in the first through third preferred embodiments described above, when the emergency warning broadcast is output by the television device, even if playback from the HDD is underway, the emergency warning broadcast preferably may also be displayed together with the playback screen without halting the playback of content being played. Furthermore, in the fourth preferred embodiment, when the DMP performs emergency notification, even if playback is underway, the emergency notification may also be displayed together with the playback screen without halting the playback of content being played.

Moreover, in cases where playback from the HDD is halted and the emergency warning broadcast is displayed in the first through third preferred embodiments, replay may be resumed when, for example, the start flag becomes 0 or when the specified period of time has elapsed, for example. In addition, in the fourth preferred embodiment, in cases where the DMP halts playback and performs emergency notification, playback may be resumed by transmitting a command from the television device when the start flag becomes 0, for example, or after a specified length of time has elapsed. Note that when resuming playback, it is preferable to resume from the playback position where it was previously halted.

Furthermore, the emergency notification control device according to various preferred embodiments of the present invention may be applied to a hard disk recorder, optical disc recorder, set top box, and the like, without being limited to a television device.

Moreover, when the television device and the DMP are connected over a network as in the fourth preferred embodiment, for example, and the television device detects that the start flag has become 1, it is also possible to transmit a region code from the television device to the DMP, to make a determination at the DMP regarding the transmitted region code, and to switch whether or not to perform emergency notification with an OSD or the like depending on the determination result. That is, in this case, the DMP becomes the emergency notification control device.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An emergency notification control device comprising:
an input unit configured to input settings reflecting user preferences;
a storage unit configured to store the settings that are input using the input unit; and
an emergency notification control unit configured and programmed to switch whether or not to perform an emergency notification based on the settings stored in the storage unit when an emergency broadcast is broadcast.

2. The emergency notification control device according to claim 1, wherein the emergency notification control unit is configured and programmed to switch whether or not to perform an emergency notification by comparing region information contained in the broadcast when the emergency broadcast is broadcast with region settings that reflect user preferences.

3. The emergency notification control device according to claim 1, wherein the emergency notification control unit is configured and programmed to switch whether or not to perform an emergency notification by comparing emergency situation type information contained in the broadcast when the emergency broadcast is broadcast with type settings that reflect user preferences.

4. The emergency notification control device according to claim 1, wherein the emergency notification control unit is configured and programmed to switch whether or not to perform an emergency notification by comparing the number of times the emergency broadcast is broadcast consecutively with a number-of-times setting that reflects user preferences.

5. The emergency notification control device according to claim 1, wherein the emergency notification control unit is configured and programmed to transmit an emergency notification command to an external device that does not have broadcast reception functions to cause the external device to perform an emergency notification.

6. The emergency notification control device according to claim 1, wherein the emergency notification control unit is configured and programmed to transmit video data to an external device that does not have broadcast reception functions to cause the external device to perform an emergency notification by playing the video data.

7. The emergency notification control device according to claim 5, wherein the external device is a digital media player connected to the emergency notification control device over a home network.

8. The emergency notification control device according to claim 1, wherein the emergency notification control device is configured to perform content playback, and when content is being played, the emergency notification control unit halts the playback operation and performs an emergency notification.

9. The emergency notification control device according to claim 8, wherein when the broadcast of the emergency broadcast terminates after the playback operation is halted, the playback operation is resumed.

10. An emergency notification system comprising:
an emergency notification control device including:
an input unit configured to input settings reflecting user preferences;
a storage unit configured to store the settings that are input using the input unit;
a detection unit configured to detect that an emergency broadcast has been broadcast; and
an emergency notification control unit configured and programmed to switch whether or not to perform an emergency notification based on the settings stored in the storage unit when the detection unit detects the emergency broadcast; and
a notification device configured to perform an emergency notification by controlling the emergency notification control unit.

11. The emergency notification system according to claim 10, wherein the notification device is configured to perform an emergency notification by on-screen display or by playing specified content upon receipt of an emergency notification command transmitted by the emergency notification control unit.

12. The emergency notification system according to claim 11, wherein the notification device is configured not to perform any emergency notification even when the emergency notification command is received.

13. The emergency notification system according to claim 10, wherein the notification device is configured to perform an emergency notification by playing video data transmitted by the emergency notification control unit.

14. The emergency notification system according to claim 10, wherein the notification device is configured to perform content playback, and emergency notification is performed after halting playback if content is being played.

15. The emergency notification system according to claim 14, wherein the emergency notification control device includes a command transmission unit configured to send a command to the notification device when the detection unit detects that the emergency broadcast has terminated, and the notification device resumes the halted playback upon receipt of the command.

16. The emergency notification system according to claim 10, wherein the emergency notification control unit is configured and programmed to switch whether or not to perform an emergency notification by comparing region information contained in the broadcast when the emergency broadcast is broadcast with region settings that reflect user preferences.

17. The emergency notification system according to claim 10, wherein the emergency notification control unit is configured and programmed to switch whether or not to perform an emergency notification by comparing emergency situation type information contained in the broadcast when the emergency broadcast is broadcast with type settings that reflect user preferences.

18. The emergency notification system according to claim 10, wherein the emergency notification control unit is configured and programmed to switch whether or not to perform an emergency notification by comparing the number of times the emergency broadcast is broadcast consecutively with a number-of-times setting that reflects user preferences.

19. The emergency notification system according to claim 10, wherein the emergency notification control unit is configured and programmed to transmit an emergency notification command to an external device that does not have broadcast reception functions to cause the external device to perform an emergency notification.

20. The emergency notification system according to claim 10, wherein the emergency notification control unit is configured and programmed to transmit video data to an external device that does not have broadcast reception functions to cause the external device to perform an emergency notification by playing the video data.
